(19) United States
(12) Patent Application Publication
(10) Pub. No.: US 2021/0103830 A1
(43) Pub. Date: Apr. 8, 2021

(54) MACHINE LEARNING BASED CLUSTERING AND PATTERNING SYSTEM AND METHOD FOR NETWORK TRAFFIC DATA AND ITS APPLICATION

(71) Applicant: AT&T Intellectual Property I, L.P., Atlanta, GA (US)

(72) Inventors: Yu Liu, Fremont, CA (US); Baofeng Jiang, Pleasanton, CA (US)

(21) Appl. No.: 16/595,662

(22) Filed: Oct. 8, 2019

(51) Int. Cl. G06N 5/04; G06N 20/00; G06F 16/906; H04W 72/04

(52) U.S. Cl. CPC G06N 5/04; H04W 72/04; G06F 16/906; G06N 20/00

(57) ABSTRACT

A method includes obtaining device data by a network, wherein the network collects data from a plurality of connected devices, selecting a key performance indicator associated with the plurality of connected devices, clustering the data in accordance with the key performance indicator to form a plurality of clustered data sets, and determining a pattern within at least one of the plurality of clustered data sets to recommend network resource allocations. The pattern may be further used to analyze a second set of device data to determine an updated pattern and wherein the updated pattern is determined based on the pattern and the second set of device data.

### TECHNICAL FIELD

This disclosure is directed to a collection and data analysis system and more specifically, to collecting and analyzing cluster traffic data to provide for efficient use of network resources and provide recommend service levels to customers.

### BACKGROUND

As the number of network-connected devices grows, now and in the evolution to 5G and beyond, the volume of data traffic will increase significantly, including mobility data traffic as well as data traffic generated by Internet of Things (IoT). It will become ever more important for network carriers to obtain more accurate data traffic characteristics to effectively and efficiently allocate limited network resources. The traditional solutions for these problems include (i) allocating resources according population density, for example, allocating differing amounts of resources between rural areas and urban areas, or (ii) adapting legacy network resource distribution models to satisfy ever changing demands. Such traditional network traffic classification methods, which are mainly focused on traffic type or network application classifications, may provide very basic clustering, However, such traditional methods of network resource allocation may provide nothing in the way of pattern analysis, model evolution, or big data supported analysis. Thus, it is difficult for carriers to provide accurate subscription and network resource distribution recommendations.

There is a need for a data analytics solution to achieve optimal network resource distributions and provide recommendations to customers with respect to service level and network resource recommendations.

### SUMMARY

The present disclosure is directed to a method including obtaining device data by a network, wherein the network collects data from a plurality of connected devices, selecting a key performance indicator associated with the plurality of connected devices, clustering the data in accordance with the key performance indicator to form a plurality of clustered data sets, and determining a pattern within at least one of the plurality of clustered data sets. The method may further include characterizing the clustered data and wherein the characterizing step is based on the key performance indicator and wherein the method further comprises recommending an allocation of network resources or a service plan based on the key performance indicator. In an aspect, the pattern may be used to analyze a second set of device data to determine an updated pattern and wherein the updated pattern is determined based on the pattern and the second set of device data. In an aspect, the clustering is performed by a k-means clustering algorithm or one of means-shift clustering, density-based spatial clustering of applications with noise, expectation-maximation clustering using Gaussian mixture models, or agglomerative hierarchical clustering. The method may further include characterizing the clustered data wherein the characterizing is based on a value of the key performance indicator.

The present invention is also directed to a method including analyzing historical unstructured device data characteristics using at least one key performance indicator, instantiating a machine learning algorithm configured to operate on the unstructured device data wherein the algorithm produces a plurality of clustered data sets in accordance with the at least one key performance indicators, determining a pattern within at least one of the plurality of clustered data sets, and optimizing a recommendation for the provisioning of network resources. In an aspect, data points are grouped into one of the plurality of clustered data sets based on similar properties with other data in the one of the plurality of clustered data sets. In an aspect, the historical unstructured device data is captured by a network from a plurality of connected devices. The method may further include comprising computing one or more key performance indicators to be used by the algorithm and wherein the one or more key performance indicators is associated with connected devices and the one or more key performance indicators is one of connected device data traffic volume, connected device network session duration, or network applications used by connected devices. In an aspect, the pattern is used as an input to the machine learning algorithm to analyze a second set of unstructured device data to determine an updated pattern and wherein the updated pattern is determined based on the pattern and the second set of unstructured device data.

The disclosure is also directed to a computer readable storage medium storing computer executable instructions that when executed by a computing device cause said computing device to effectuate operations including obtaining device data by a network, wherein the network collects data from a plurality of connected devices, selecting a key performance indicator associated with the plurality of connected devices, clustering the data in accordance with the key performance indicator to form a plurality of clustered data sets, and determining a pattern within at least one of the plurality of clustered data sets. The operations may further comprise characterizing the clustered data. In an aspect, the characterizing step is based on the key performance indicator and wherein the operations further include recommending an allocation of network resources based on the key performance indicator. The operations may further include an allocation of network resources based on the key performance indicator. In an aspect, the pattern is used to analyze a second set of device data to determine an updated pattern and wherein the updated pattern is determined based on the pattern and the second set of device data.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for implementing collecting bulk data.

FIG. 2A illustrates an exemplary diagram of collected unstructured data.

FIG. 2B illustrates an exemplary diagram of collected unstructured data with two initial means selected.

FIG. 2C illustrates an exemplary diagram of collected unstructured data of FIG. 2B defining two clusters.

FIG. 2D illustrates an exemplary diagram of collected unstructured data of FIG. 2C after a first means calculation.

FIG. 2E illustrates an exemplary diagram of collected unstructured data of FIG. 2D after a second means calculation.

FIG. 2F illustrates an exemplary diagram of collected unstructured data of FIG. 2E after a third means calculation.

FIG. 3 illustrates an exemplary method for implementing bulk data processing.

FIG. 4 illustrates a schematic of an exemplary network device.

FIG. 5 illustrates an exemplary communication system that provides wireless telecommunication services over wireless communication networks.

FIG. 6A is a representation of an exemplary network.

FIG. 6B is a representation of an exemplary hardware platform for a network.

### DETAILED DESCRIPTION

System Overview. This disclosure is directed to a novel system and method which uses machine-learning algorithms to classify the characteristics and patterns of network data traffic. The system and method provide a clustering analysis of network traffic characteristics by using unsupervised machine learning algorithms and then proposing appropriate recommendations based on the clustering results. The network data traffic can be mobile data traffic associated with User Equipment (UE) communications, connected car traffic, and other IoT traffic. Unless otherwise specified in this disclosure, the term “device data” will be used to represent any type of network traffic data collected and used in accordance with the systems and methods of the present disclosure. Unless otherwise specified, the terms “key performance identifier” and “key performance indicator” and their respective plural forms are meant to be synonymous. In an aspect, device data used for modeling may be near real-time cell trace data. The patterns of network traffic may include data traffic volume, network session duration time, network applications, APNs, and the like.

The steps of the method may include analyzing historical device data traffic characteristics captured by a network using key performance identifiers, including device data traffic volume, network session duration, network applications, APNs, and the like, performing a clustering analysis of these key performance identifiers of device data traffic using machine learning clustering algorithms, detecting patterns and features of such device data traffic, and then providing recommendations to seamlessly provision data traffic in an efficient manner.

The clustering technique may involve the grouping of data points of cell trace data, which may, for example, contain near real time cell level mobility network data for each individual user device and all IoT related data. The data resource contains each device type, cell location and the level of data usage volume and other statistics for each user device. Given the set of data points, a clustering algorithm may classify each data point into a specific group with other data having similar properties and/or features. Such clustering is a method of unsupervised learning. Any number of clustering algorithms may be used on the device data. This and other functionality will be described in greater detail below

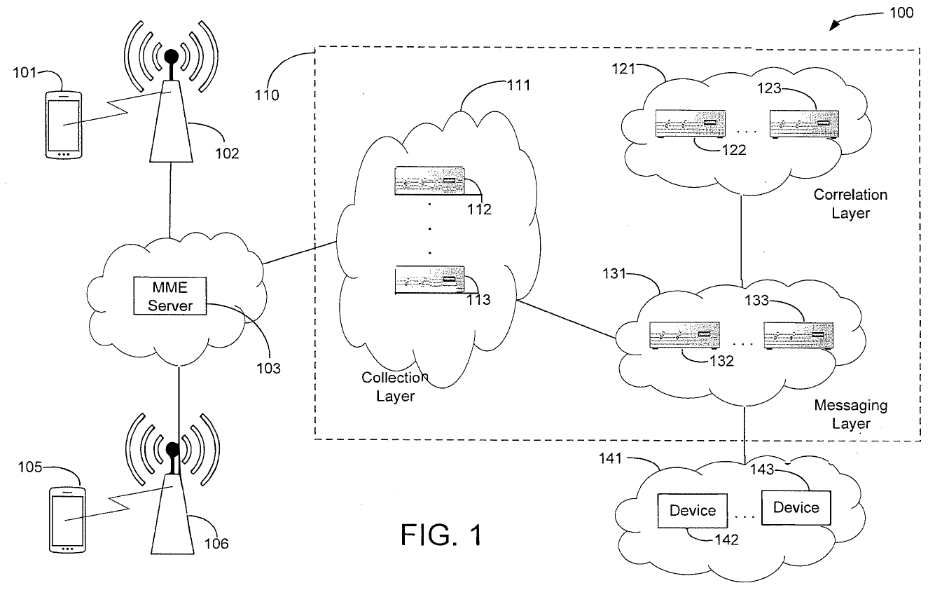

Operating Environment. The system and method provided herein allows real time or near real time collection and processing of massive device data from an operating network, mainly per user device data and IoT data. The system and method of the present disclosure is agnostic to the method of collection and the apparatus used therefore. As an example only of an operating environment, a process used in a Streaming Events and Mediation (STEM) process developed by the assignee of this disclosure will be described in conjunction with FIG. 1 and FIGS. 4-6.

FIG. 1 illustrates an exemplary system 100 for implementing bulk data processing. As shown, there may be mobile device 101 or mobile device 105 (e.g., laptop, tablet, interne of things devices), which may be connected with eNodeB 102 or eNodeB 106. Mobility Management Entity (MME) 103 may be connected with a STreaming Events and Mediation (STEM) layer 110, which may include a network of servers with different sub-layers (e.g., collections of servers—network 111, network 121, network 131) that collect and process data in a particular manner. Network 111 may include devices, such as server 112 or server 113, which process data for a collection layer.

Network 121 may include devices, such as server 122 or server 123, which process data for a correlation layer. Network 131 may include devices, such as server 132 or server 133, which process data for a messaging layer. Network 141 may include devices, such as device 142 or server 143, which process data for an application layer. The elements of system 100 may be communicatively connected with each other.

Collector network 111 may be used for obtaining (e.g., collecting) device data from network elements which originate from connected devices 101, 105. There may be multiple types of collectors in collector network 111 with each type designed to handle data ingestion for a specific vendor data format and transmission mechanism. Depending on the mechanism involved, the collector network 111 may obtain the data and performs initial decoding of the data.

Using the above-described STEM process or any other process for collecting device data from connected network devices, there may be large amounts of unstructured data sets to be used in the system and methods described herein.

Clustering machine learning algorithms, and specifically a k-means clustering machine learning algorithm applied to unstructured data sets may be used in conjunction with the present disclosure. Such algorithms are intended to produce clusters of like data, including identifying the central points for the various clusters and defining the type or classification of data points within each cluster. In a typical embodiment, k-means finds the best central point of the cluster by iteratively assigning collected data points to clusters based on the current central point and then selecting central points of the cluster based on the current assignment of data points to clusters.

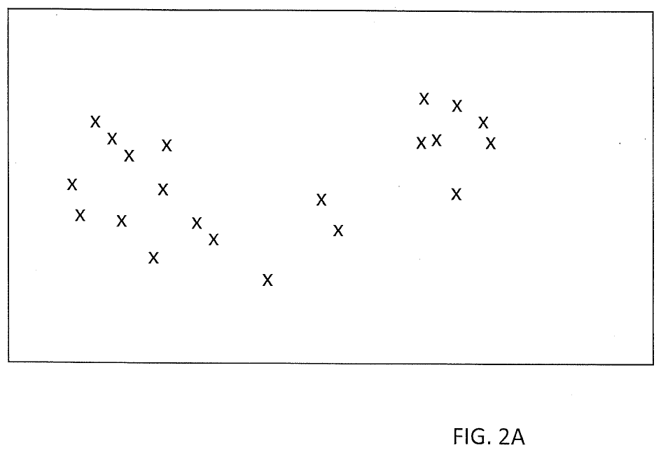

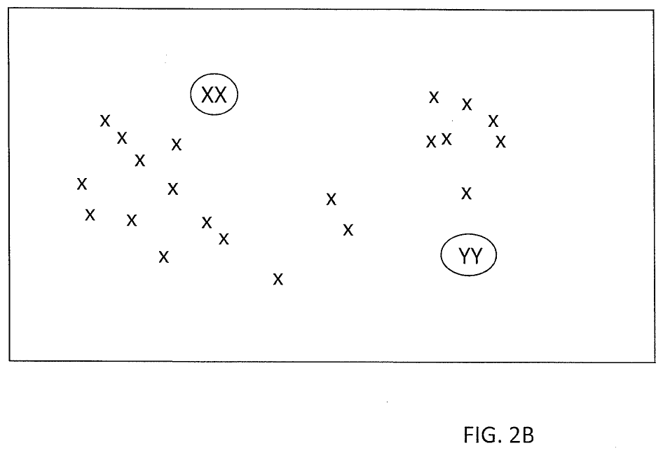

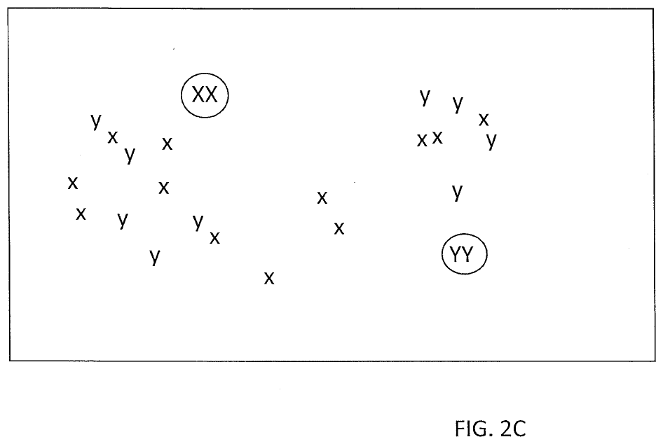

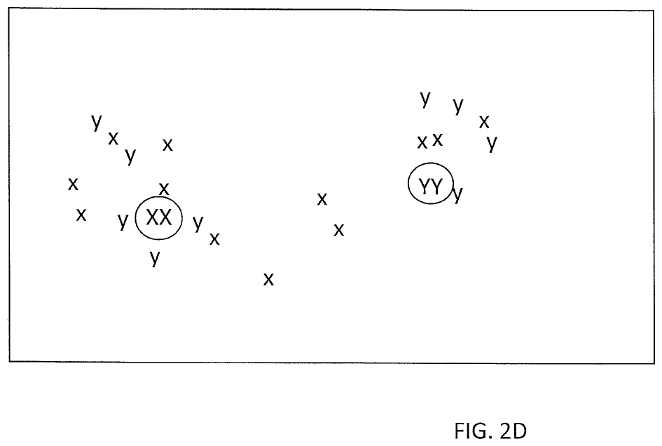

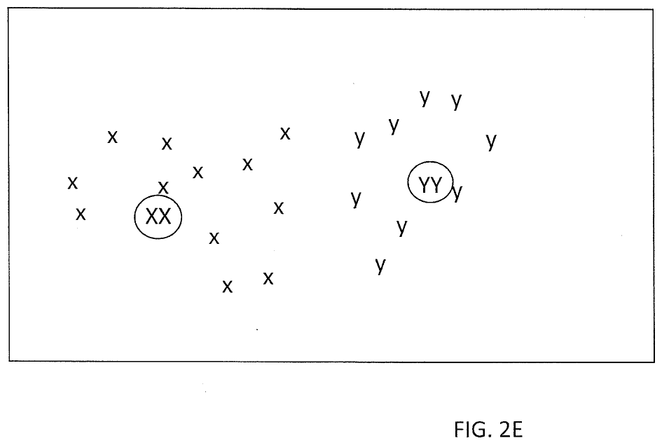

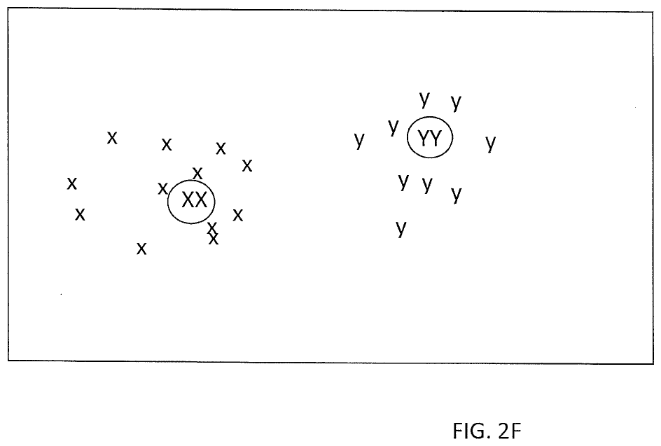

FIGS. 2A through 2F provide a visual example of a k-means clustering algorithm. In this example, the operator may be using the key performance indicator of data volume to identify higher volume data users and lower volume data users.

FIG. 2A shows an unstructured raw data set, which may, for example, be representative of a raw data set collected from network traffic. Each data point is represented by an “x.” This data set may, for example, be a collection of data for a set of connected devices showing the volume of data each connected device consumed during a particular time period. In the example diagram of FIG. 2A, the collected data is unstructured and has not yet been analyzed for clusters or pattern recognition.

FIG. 2B shows exemplary initial center points of two clusters, shown as an XX and a YY, wherein the XX may represent a mean value for the lower data volume users and the YY may represent the mean for the higher data volume users.

FIGS. 2C through 2F show successive iterations of exemplary k-means calculations in which clusters are formed. In FIG. 2C, each data sample is assigned to the closest cluster comprising the same data point type. For example, lower data volume users are represented by “x” and assigned to the cluster with the initial mean represented by “XX” and the higher volume data users are represented by “y” and assigned to the cluster with the initial mean represented by “YY.” The respective means for each of the “x” clusters and “y” clusters are calculated and shown in FIG. 2D. Successive iterations of the mean calculation are shown in FIGS. 2E and 2F.

In using a k-means clustering algorithm, any number of iterations may be specified, and any number of individual clusters may be specified. While the present disclosure used k-means clustering as an exemplary machine learning algorithm applied to unstructured data sets, it will be understood that other clustering machine learning algorithms may be used consistent with the present disclosure and within the scope of the claims appended hereto. For example, clustering algorithms such as means-shift clustering, density-based spatial clustering of applications with noise, expectation-maximation clustering using Gaussian mixture models, or agglomerative hierarchical clustering may also be used.

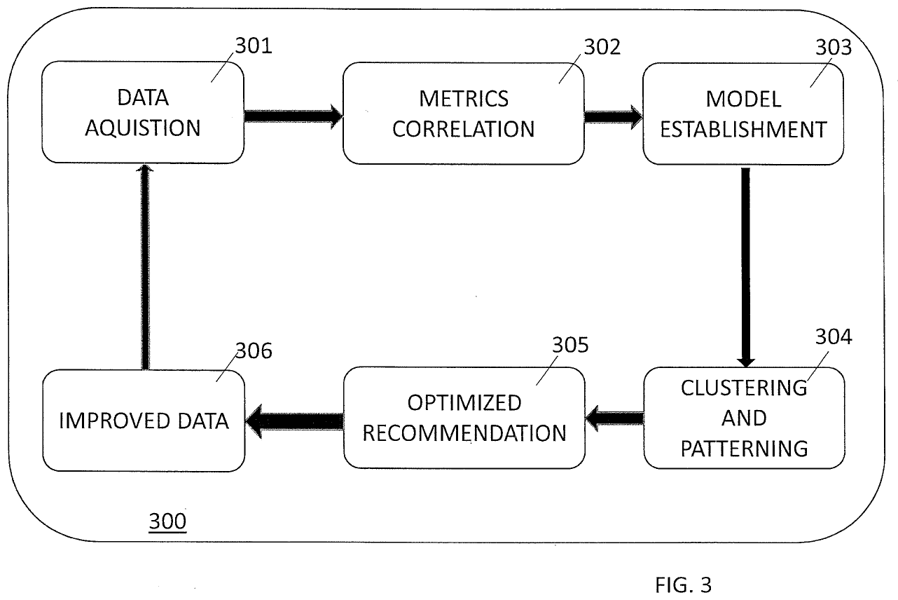

FIG. 3 illustrates an exemplary method 300 for implementing the system and method of the present disclosure. At 301, the data acquisition function may be started. In an aspect, the device data to be acquired may include data collected in real time or near real time by data collection functionality discussed above. The data collected may be device data and include data associated with each network-attached UE, connected vehicle, IoT devices, or other connected devices. The device data may include data that identifies or relates to each device type, cell or edge connection location, data usage volumes, data speeds, data latency, and other key performance indicators or statistical data. The device data may be unstructured.

At 302, there may be a metrics correlation function. At this step, computations for key performance identifiers used for clustering may be executed. The key performance indicators may serve to identify data as data points in a particular data set which data set may, for example, be selected based on the key performance indicator. For example, in the example used with respect to FIG. 2a through FIG. 2b above, the key performance indicator of traffic volume was used to correlate high data usage devices and lower data usage devices. It will be understood that other key performance indicators may be used for clustering and may include, but not limited to, traffic data usage, session duration time, applications accessed, service levels, latency, data speeds and other performance metrics.

At 303, a machine learning model may be established. For example, an unsupervised machine learning clustering algorithm may be used, which may, for example be a k-means clustering algorithm or any other clustering algorithm to generate a clustering model. The clustering model may then classify the device data traffic based on different patterns of the data and which may, classify the device data based on an attribute of one or more key performance indicators.

At 304, there may be a clustering and patterning function may be performed to detect data traffic patterns or characteristic in each cluster. There are various significant characteristics or patterns that may be ascertained from each cluster. For example, each cluster may have a characteristic based on the monthly data usage volume. Within each cluster, each device type may be identified, the various applications that each device accessed, the location of each device, and other metrics may be analyzed to develop patterns within each cluster. At 305, the recommendation function may be performed based on the clustering and patterning functions. The recommendations may include, for example, network resource allocation, customer subscription options, etc. The recommendations are generated by analyzing patterns in each clustering. For example, for the cluster with high volume of monthly data usage, we can investigate their device types or applications which contribute to high volume of data usage. For those users with devices that consume high monthly data usages, a potential recommended optimization may include a suggestion that the user or group of users switch service plans to an unlimited data plan subscription option.

At 306, the data analytics performed, and the recommendations associated therewith, such as network resource allocations and customer subscriptions, may be further fed into the database to promote the machine learning development. This forms a semi-closed loop system which permits the machine learning model to evolve while allowing for the ingestion of additional device data to be processed.

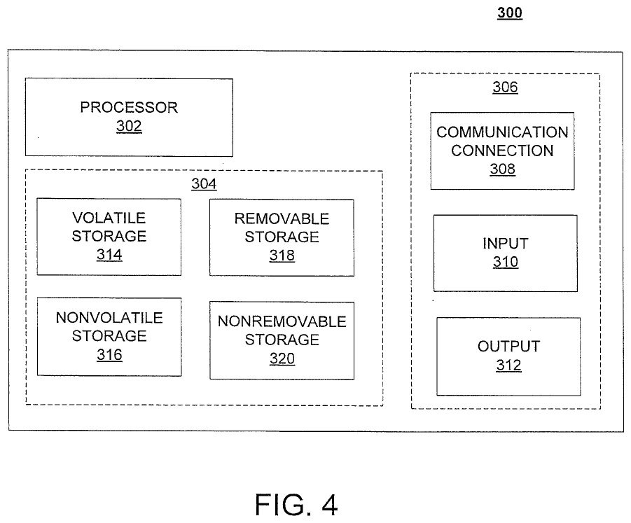

Network Description. FIG. 4 is a block diagram of network device 300 that may be connected to FIG. 1 or which may be a component of FIG. 1. Network device 300 may comprise hardware or a combination of hardware and software. The functionality to facilitate telecommunications via a telecommunications network may reside in one or combination of network devices 300. Network device 300 depicted in FIG. 4 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 4 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength. As evident from the description herein, network device 300 is not to be construed as software per se.

In addition to processor 302 and memory 304, network device 300 may include an input/output system 306. Processor 302, memory 304, and input/output system 306 may be coupled together (coupling not shown in FIG. 4) to allow communications between them. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

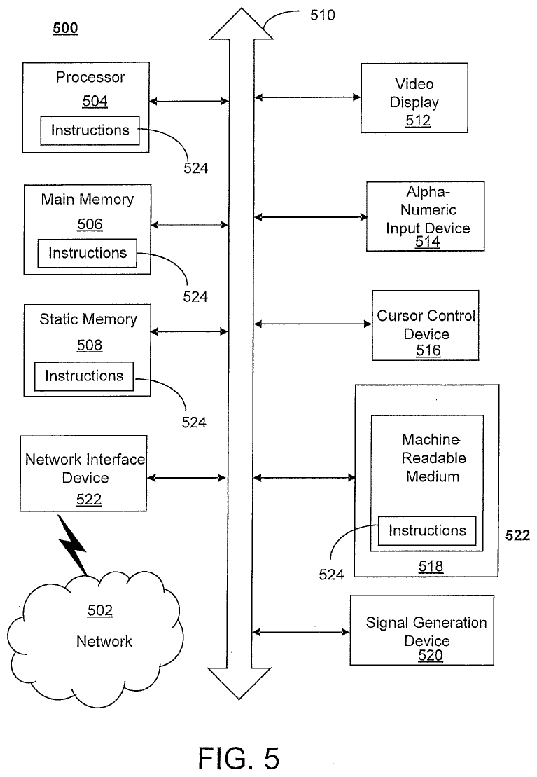

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 302, server 112, mobile device 101, eNB 102, MME 103, and other devices of FIG. 1 and FIG. 2. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, internet of things (IOT) device (e.g., thermostat, sensor, or other machine-to-machine device), or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid-state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

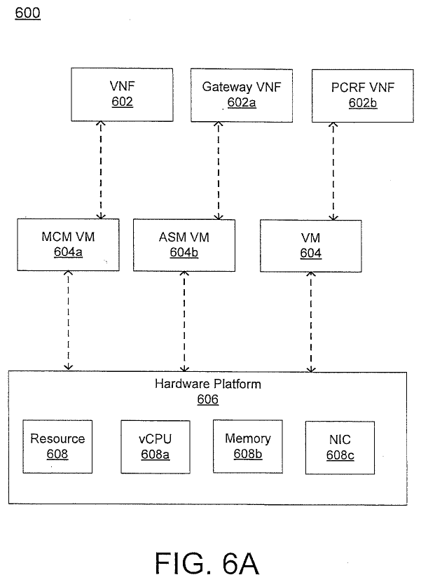

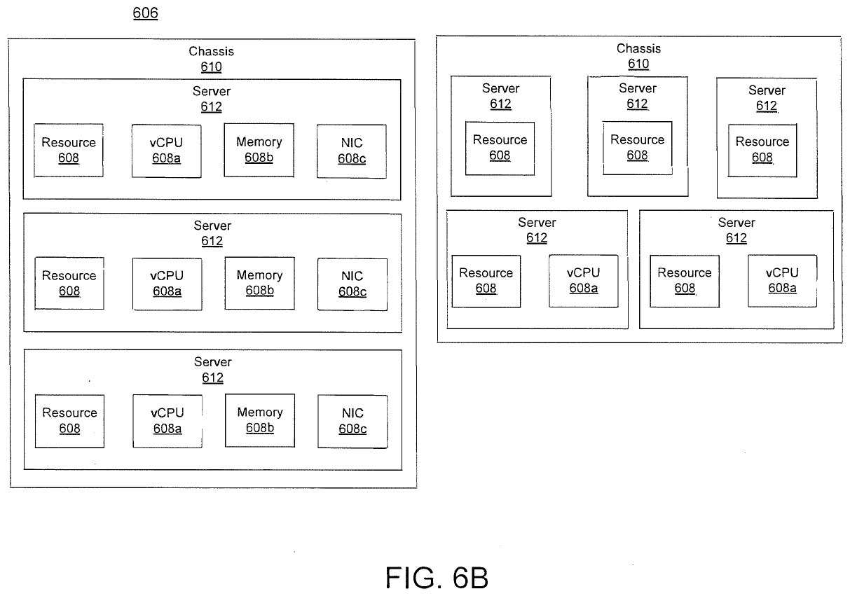

FIG. 6A is a representation of an exemplary network 600. Network 600 (e.g., network 111) may comprise an SDN—that is, network 600 may include one or more virtualized functions implemented on general purpose hardware, such as in lieu of having dedicated hardware for every network function. That is, general purpose hardware of network 600 may be configured to run virtual network elements to support communication services, such as mobility services, including consumer services and enterprise services. These services may be provided or measured in sessions.

A virtual network functions (VNFs) 602 may be able to support a limited number of sessions. Each VNF 602 may have a VNF type that indicates its functionality or role. For example, FIG. 6A illustrates a gateway VNF 602a and a policy and charging rules function (PCRF) VNF 602b. Additionally or alternatively, VNFs 602 may include other types of VNFs. Each VNF 602 may use one or more virtual machines (VMs) 604 to operate. Each VM 604 may have a VM type that indicates its functionality or role. For example, FIG. 6A illustrates a management control module (MCM) VM 604a, an advanced services module (ASM) VM 604b, and a DEP VM 604c. Additionally or alternatively, VMs 604 may include other types of VMs. Each VM 604 may consume various network resources from a hardware platform 606, such as a resource 608, a virtual central processing unit (vCPU) 608a, memory 608b, or a network interface card (NIC) 608c. Additionally or alternatively, hardware platform 606 may include other types of resources 608.

While FIG. 6A illustrates resources 608 as collectively contained in hardware platform 606, the configuration of hardware platform 606 may isolate, for example, certain memory 608c from other memory 608c. FIG. 6B provides an exemplary implementation of hardware platform 606.

Hardware platform 606 may comprise one or more chasses 610. Chassis 610 may refer to the physical housing or platform for multiple servers or other network equipment. In an aspect, chassis 610 may also refer to the underlying network equipment. Chassis 610 may include one or more servers 612. Server 612 may comprise general purpose computer hardware or a computer. In an aspect, chassis 610 may comprise a metal rack, and servers 612 of chassis 610 may comprise blade servers that are physically mounted in or on chassis 610.

Each server 612 may include one or more network resources 608, as illustrated. Servers 612 may be communicatively coupled together (not shown) in any combination or arrangement. For example, all servers 612 within a given chassis 610 may be communicatively coupled. As another example, servers 612 in different chasses 610 may be communicatively coupled. Additionally, or alternatively, chasses 610 may be communicatively coupled together (not shown) in any combination or arrangement.

The characteristics of each chassis 610 and each server 612 may differ. For example, FIG. 6B illustrates that the number of servers 612 within two chasses 610 may vary. Additionally, or alternatively, the type or number of resources 610 within each server 612 may vary. In an aspect, chassis 610 may be used to group servers 612 with the same resource characteristics. In another aspect, servers 612 within the same chassis 610 may have different resource characteristics.

Given hardware platform 606, the number of sessions that may be instantiated may vary depending upon how efficiently resources 608 are assigned to different VMs 604. For example, assignment of VMs 604 to particular resources 608 may be constrained by one or more rules. For example, a first rule may require that resources 608 assigned to a particular VM 604 be on the same server 612 or set of servers 612. For example, if VM 604 uses eight vCPUs 608a, 1 GB of memory 608b, and 2 NICs 608c, the rules may require that all of these resources 608 be sourced from the same server 612. Additionally, or alternatively, VM 604 may require splitting resources 608 among multiple servers 612, but such splitting may need to conform with certain restrictions. For example, resources 608 for VM 604 may be able to be split between two servers 612. Default rules may apply. For example, a default rule may require that all resources 608 for a given VM 604 must come from the same server 612.

An affinity rule may restrict assignment of resources 608 for a particular VM 604 (or a particular type of VM 604). For example, an affinity rule may require that certain VMs 604 be instantiated on (that is, consume resources from) the same server 612 or chassis 610. For example, if VNF 602 uses six MCM VMs 604a, an affinity rule may dictate that those six MCM VMs 604a be instantiated on the same server 612 (or chassis 610). As another example, if VNF 602 uses MCM VMs 604a, ASM VMs 604b, and a third type of VMs 604, an affinity rule may dictate that at least the MCM VMs 604a and the ASM VMs 604b be instantiated on the same server 612 (or chassis 610). Affinity rules may restrict assignment of resources 608 based on the identity or type of resource 608, VNF 602, VM 604, chassis 610, server 612, or any combination thereof.

An anti-affinity rule may restrict assignment of resources 608 for a particular VM 604 (or a particular type of VM 604). In contrast to an affinity rule—which may require that certain VMs 604 be instantiated on the same server 612 or chassis 610—an anti-affinity rule requires that certain VMs 604 be instantiated on different servers 612 (or different chasses 610). For example, an anti-affinity rule may require that MCM VM 604a be instantiated on a particular server 612 that does not contain any ASM VMs 604b. As another example, an anti-affinity rule may require that MCM VMs 604a for a first VNF 602 be instantiated on a different server 612 (or chassis 610) than MCM VMs 604a for a second VNF 602. Anti-affinity rules may restrict assignment of resources 608 based on the identity or type of resource 608, VNF 602, VM 604, chassis 610, server 612, or any combination thereof.

Within these constraints, resources 608 of hardware platform 606 may be assigned to be used to instantiate VMs 604, which in turn may be used to instantiate VNFs 602, which in turn may be used to establish sessions. The different combinations for how such resources 608 may be assigned may vary in complexity and efficiency. For example, different assignments may have different limits of the number of sessions that can be established given a particular hardware platform 606.

For example, consider a session that may require gateway VNF 602a and PCRF VNF 602b. Gateway VNF 602a may require five VMs 604 instantiated on the same server 612, and PCRF VNF 602b may require two VMs 604 instantiated on the same server 612. (Assume, for this example, that no affinity or anti-affinity rules restrict whether VMs 604 for PCRF VNF 602b may or must be instantiated on the same or different server 612 than VMs 604 for gateway VNF 602a.) In this example, each of two servers 612 may have sufficient resources 608 to support 10 VMs 604. To implement sessions using these two servers 612, first server 612 may be instantiated with 10 VMs 604 to support two instantiations of gateway VNF 602a, and second server 612 may be instantiated with 9 VMs: five VMs 604 to support one instantiation of gateway VNF 602a and four VMs 604 to support two instantiations of PCRF VNF 602b. This may leave the remaining resources 608 that could have supported the tenth VM 604 on second server 612 unused (and unusable for an instantiation of either a gateway VNF 602a or a PCRF VNF 602b). Alternatively, first server 612 may be instantiated with 10 VMs 604 for two instantiations of gateway VNF 602a and second server 612 may be instantiated with 10 VMs 604 for five instantiations of PCRF VNF 602b, using all available resources 608 to maximize the number of VMs 604 instantiated.

Consider, further, how many sessions each gateway VNF 602a and each PCRF VNF 602b may support. This may factor into which assignment of resources 608 is more efficient. For example, consider if each gateway VNF 602a supports two million sessions, and if each PCRF VNF 602b supports three million sessions. For the first configuration—three total gateway VNFs 602a (which satisfy the gateway requirement for six million sessions) and two total PCRF VNFs 602b (which satisfy the PCRF requirement for six million sessions)—would support a total of six million sessions. For the second configuration—two total gateway VNFs 602a (which satisfy the gateway requirement for four million sessions) and five total PCRF VNFs 602b (which satisfy the PCRF requirement for 15 million sessions)—would support a total of four million sessions. Thus, while the first configuration may seem less efficient looking only at the number of available resources 608 used (as resources 608 for the tenth possible VM 604 are unused), the second configuration is actually more efficient from the perspective of being the configuration that can support more the greater number of sessions.

To solve the problem of determining a capacity (or, number of sessions) that can be supported by a given hardware platform 605, a given requirement for VNFs 602 to support a session, a capacity for the number of sessions each VNF 602 (e.g., of a certain type) can support, a given requirement for VMs 604 for each VNF 602 (e.g., of a certain type), a give requirement for resources 608 to support each VM 604 (e.g., of a certain type), rules dictating the assignment of resources 608 to one or more VMs 604 (e.g., affinity and anti-affinity rules), the chasses 610 and servers 612 of hardware platform 606, and the individual resources 608 of each chassis 610 or server 612 (e.g., of a certain type), an integer programming problem may be formulated.

As described herein, a telecommunications system wherein management and control utilizing a software designed network (SDN) and a simple IP are based, at least in part, on user equipment, may provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a telecommunications system in which bulk data processing messages can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing telecommunications as described herein. When implemented on a general-purpose processor, the program code combines with the processor to provide a unique device that operates to invoke the functionality of a telecommunications system.

While a telecommunications system has been described in connection with the various examples of the various figures, it is to be understood that other similar implementations may be used, or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, a telecommunications system as described herein should not be limited to any single example, but rather should be construed in breadth and scope in accordance with the appended claims.

In describing preferred methods, systems, or apparatuses of the subject matter of the present disclosure as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. In addition, the use of the word “or” is generally used inclusively unless otherwise provided herein.

This written description uses examples to enable any person skilled in the art to practice the claimed subject matter, including making and using any devices or systems and performing any incorporated methods. The patentable scope of the disclosed subject matter is defined by the claims and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

1. A method comprising:
obtaining device data by a network, wherein the network collects data from a plurality of connected devices;
selecting a key performance indicator associated with the plurality of connected devices;
clustering the data in accordance with the key performance indicator to form a plurality of clustered data sets; and
determining a pattern within at least one of the plurality of clustered data sets.

2. The method of claim 1 further comprising characterizing the clustered data.

3. The method of claim 2 wherein the characterizing step is based on the key performance indicator and wherein the method further comprises recommending an allocation of network resources based on the key performance indicator.

4. The method of claim 1 further comprising recommending an allocation of network resources based on the determining step.

5. The method of claim 1 further comprising recommending a service plan based on the determining step.

6. The method of claim 1 wherein the pattern is used to analyze a second set of device data to determine an updated pattern and wherein the updated pattern is determined based on the pattern and the second set of device data.

7. The method of claim 1 wherein the clustering is performed by a k-means clustering algorithm.

8. The method of claim 1 wherein the clustering is performed by one of means-shift clustering, density-based spatial clustering of applications with noise, expectation-maximation clustering using Gaussian mixture models, or agglomerative hierarchical clustering.

9. The method of claim 1 further comprising characterizing the clustered data wherein the characterizing is based on a value of the key performance indicator.

10. A method comprising:
analyzing historical unstructured device data characteristics using at least one key performance indicator;
instantiating a machine learning algorithm configured to operate on the unstructured device data wherein the algorithm produces a plurality of clustered data sets in accordance with the at least one key performance indicators;
determining a pattern within at least one of the plurality of clustered data sets; and
optimizing a recommendation for the provisioning of network resources.

11. The method of claim 10 wherein data points are grouped into one of the plurality of clustered data sets based on similar properties with other data in the one of the plurality of clustered data sets.

12. The method of claim 10 wherein the historical unstructured device data is captured by a network from a plurality of connected devices.

13. The method of claim 10 further comprising computing one or more key performance indicators to be used by the algorithm.

14. The method of claim 10 wherein the one or more key performance indicators is associated with connected devices and the one or more key performance indicators is one of connected device data traffic volume, connected device network session duration, or network applications used by connected devices.

15. The method of claim 10 wherein the pattern is used as an input to the machine learning algorithm to analyze a second set of unstructured device data to determine an updated pattern and wherein the updated pattern is determined based on the pattern and the second set of unstructured device data.

16. A computer readable storage medium storing computer executable instructions that when executed by a computing device cause said computing device to effectuate operations comprising:
obtaining device data by a network, wherein the network collects data from a plurality of connected devices;
selecting a key performance indicator associated with the plurality of connected devices;
clustering the data in accordance with the key performance indicator to form a plurality of clustered data sets; and
determining a pattern within at least one of the plurality of clustered data sets.

17. The computer readable storage medium of claim 16 wherein the operations further comprise characterizing the clustered data.

18. The computer readable storage medium of claim 17 wherein the characterizing step is based on the key performance indicator and wherein the operations further comprise recommending an allocation of network resources based on the key performance indicator.

19. The computer readable storage medium of claim 16 the pattern is used to analyze a second set of device data to determine an updated pattern and wherein the updated pattern is determined based on the pattern and the second set of device data.

20. The computer readable storage medium of claim 19 wherein the operations further comprise recommending an allocation of network resources based on the key performance indicator.
